(19) United States
(12) Patent Application Publication
(10) Pub. No.: US 2005/0256262 A1
(43) Pub. Date: Nov. 17, 2005

(54) Coating or composite moulding or mastic composition comprising additives based on cellulose microfibrils

(76) Inventors: Alain Hill, Rueil Malmaison (FR); Isabelle Silberzan, Paris (FR)

Correspondence Address: WHYTE HIRSCHBOECK DUDEK S C, 555 EAST WELLS STREET, SUITE 1900, MILWAUKEE, WI, 53202, US

(21) Appl. No.: 11/072,991

(22) Filed: Mar. 4, 2005

Related U.S. Application Data
(60) Provisional application No. 60/565,216, filed on Apr. 23, 2004.

(30) Foreign Application Priority Data
Mar. 8, 2004 (FR) 04/02416

(51) Int. Cl. C08L 97/02

(52) U.S. Cl. 524/702

(57) ABSTRACT

The invention relates to a coating or composite moulding or mastic composition comprising, by weight: A) 100 parts of at least one reactive or non-reactive organic binder B) 0.001 to 20 parts of at least one additive comprising cellulose microfibrils modified at the surface by at least one compound B1, the said cellulose microfibrils having an aspect ratio l/d of greater than 20 and a mean cross-section d ranging from 1 to 50 nm, the said compound B1 having at least one hydrophilic part and at least one hydrophobic part, the said microfibrils being modified at the surface by physical route, by physical adsorption of the said compound B1 C) optionally, at least one organic diluent D) optionally, up to 300 parts of at least one component chosen from fillers, fibres, pigments, dyes and other conventional additives. The invention also relates to a specific process for the preparation of this composition, to specific uses and to an intermediate composition for the preparation of such a composition.

### CROSS REFERENCE TO RELATED APPLICATION

This application claims the benefit of U.S. provisional application Ser. No. 60/565,216 filed on Apr. 23, 2004, pending.

The present invention relates to coating or composite moulding or mastic compositions comprising specific additives based on cellulose microfibrils, to a specific -process for the preparation of these compositions, to specific uses and to an intermediate composition in the preparation of such compositions. These specific additives are rheology agents having a shear-thinning effect and more particularly a thixotropic effect which is significantly improved with respect to the conventional thixotropic agents of the state of the art. These additives will be generally named as thixotropic additives in this description.

The use of thixotropic agents in coating compositions based on organic solvents,otherwise called non aqueous coating systems, of the following types: paints, varnishes, gel coats, inks, adhesives in a solvent medium, leaktightness agents (meaning sealants), composite moulding compositions, and mastics, is well known and widespread in the industries concerned. The most commonly used rheology additives in the preparation of such compositions include inorganic agents, such as bentonites or other clays, particularly hydrophobically modified clays or silicas including hydrophobic modified silicas, or organic agents based on fatty acid diamides or castor oil derivatives or alkyds modified by a polyester or a polyamide or of diurea-diurethane type. However, the use of such rheological additives is relatively limited by problems of dispersion and/or of sedimentation in the applicational formulations. The use of such compositions and in particular of such a formulated coating thus becomes difficult: low rate of recovery after shearing, low resistance to sagging, in particular for thick layers. More particularly, for fatty acid diamides, particularly for powders, a significant limitation exists in the form of a stage of thermal activation in situ of the additive, which extends the time for the manufacture of said composition and renders the final performance dependant on the thermal history of the activated formulation.

Cellulose microfibrils are known in the prior art for their ability to act as thickening agent, in particular in an aqueous medium; this is due to their very high aspect ratio, which corresponds to the ratio of the length of the microfibril to its cross-section, and to the good dispersibility of the microfibrils in an aqueous medium. Such cellulose microfibrils are produced by mechanical treatment of cellulose fibres of various origins, so as to significantly increase their specific surface and to reduce their size in terms of cross-section and of length, up to the optimum size of the microfibrils. Such a treatment is disclosed in U.S. Pat. No. 4,341,807.

More particularly, according to EP 726 356, parenchyma cellulose microfibrils have a shear-thinning and thixotropic effect in an aqueous medium. However, when attempts are made to disperse these cellulose microfibrils in organic solvents, in particular non-polar or weakly polar organic solvents, very rapid flocculation takes place, explained by the pronounced hydrophilic nature of the cellulose. This nature promotes interactions between microfibrils via hydrogen bonds and does not promote interactions with the solvent and consequently does not promote the stability of the dispersion.

Surface treatments of cellulose have been provided in order to render it hydrophobic and consequently compatible with a solvent medium. Thus, WO 02/18486 discloses the use of cellulose fibres, obtained by bacterial fermentation, mixed with surfactants and/or with other coagents, as rheology-modifying agent. However, the cellulose fibres used have a higher cross-section than the abovementioned microfibrils and, consequently, a lower specific surface (specific area).

EP 1 114 065 discloses cellulose microfibrils chemically modified via ether bridges grafted to the hydroxyls present on the surface of the cellulose microfibrils.

Moreover, EP 1 192 215 discloses cellulose microfibrils modified by adsorption of a compound of surfactant type but it does not disclose the interest of these compounds in compositions as defined according to the present invention.

The technical problem of the invention, with respect to the prior art, is essentially based on the search for a compromise in performance not satisfied by the state of the prior art, for coating or composite moulding or mastic compositions, in terms:
of greater resistance to sagging, in particular enabling depositing thick layers,
of stability on storage,
of absence of delamination between two coating layers,
need of thixotropic additive, simple to use and without limitation in use.

The solution to this problem is based on the use of specific additives based on modified cellulose microfibrils, more particularly as thixotropic agent, which do not require any preliminary thermal activation and which are easy to employ in the final formulation.

Thus, the present invention demonstrates that it is possible to overcome the disadvantages of the additives conventionally used in coating compositions, of the paint or varnish or gel coat or ink or adhesive in a solvent medium or leaktightness agent type, or composite moulding or mastic compositions, by the use of additives based on specifically modified cellulose microfibrils, under specific conditions and according to the application of the final formulation.

The present invention provides, as solution to the problem defined above, a coating or composite moulding or mastic composition comprising in addition to an organic binder A, as thixotropic agent, at least one specific additive B based on cellulose microfibrils which are modified at the surface by at least one compound B1, the said cellulose microfibrils having an aspect ratio l/d (l being the length) of greater than 20 and a mean cross-section d ranging from 1 to 50 nm, the said compound B1 having:
i) at least one hydrophilic part and at least one hydrophobic part, in the case of a modification by a physical route,
ii) at least one hydrophobic part and a group which is reactive with regard to the surface functional groups of the cellulose microfibrils, in the case of a modification by a chemical route.

The solution according to the present invention makes it possible to deposit very thick coating or composite moulding or mastic layers in a single step, without sagging or without flowing, and makes possible an improvement in the mechanical performance, more particularly hardness of the composition according to the invention. It is very easy to prepare these compositions as the thixotropic agent mixes easily with the composition; it can be added at any point and it does not require any physical or chemical activation, either beforehand or in situ, and its performance is independent of the thermal history of the activated formulation and of the storage conditions, before end-use.

Mention may be made, among the additional advantages of the present invention with respect to the state of the prior art, of the following: application with a strong shear-thinning nature, within a wide shear rate range, enabling various applications, ranging from application with a brush to application with a gun of airless type, making it possible to obtain very thick layers (several millimetres in a single pass), without the generation of sagging. The composition modified with the additive based on cellulose microfibrils also exhibits a thixotropic effect which is not affected by a rise in temperature during storage. Other advantages of the invention are very good adhesion without delamination between two coating layers and with increased resistance to delamination. The moment of introduction of the microfibrils into the coating or composite moulding or mastic composition is also left to the choice of the formulator (end-user), the significantly reduced exposure time of the operator to volatile organic compounds (VOC) generated by the formulations, the reduced application cost and the reduced immobilization time of the application equipment, resulting in a significantly increased productive output.

More particularly, among the advantages of the mastic compositions according to the invention, we can cite their application at a constant flow rate, the thickness of the mastic joint then being uniform, the fact that the mastic can be extruded while maintaining the form which has been given to it at the start, which confers an exceptional dimensional stability thereon, without any need of thermal activation. The level of additive based on cellulose microfibrils according to the invention can be adjusted according to: the desired thixotropic effect, the application and the processing at the end.

Thus, the first subject-matter of the invention is a coating or composite moulding or mastic composition comprising at least one organic binder A and at least one specific additive B based on cellulose microfibrils modified at the surface by at least one compound B1 having:
i) at least one hydrophilic part and at least one hydrophobic part, in the case of a modification by a physical route,
ii) at least one hydrophobic part and a group which is reactive with regard to the surface functional groups of the cellulose microfibrils, in the case of a modification by a chemical route.

The second subject-matter of the invention is a simple process for the preparation of such compositions from modified cellulose microfibrils originating from a plant or bacterial source or animal source, with the additional advantage of adapting the additive more specifically to each of the target applications, and with ready processing.

Another subject-matter of the invention is a method of use of the composition according to the invention in various types of applications, such as paints, varnishes, gel coats, inks, adhesives in a solvent medium, leaktightness agents (sealants), composite moulding compositions and mastic compositions.

The term “moulding compositions” means everywhere it is cited in the present invention : a composition for moulded parts or articles, like SMC (sheet moulding compounds) or laminates such as boat hulls or composite boards or cast moulded articles.

The invention also covers an intermediate composition, preconcentrated in additive, which can be used for the preparation of the final applicational composition according to the invention, this intermediate composition comprising the thixotropic additive at a more concentrated level than the final coating or composite moulding or mastic composition as defined according to the invention.

The term “moulding composition” means, everywhere where it is mentioned in the present invention, a composition for moulded components, SMC type, or laminates, boat hulls type, or composite panels, or components moulded by casting.

The first subject-matter of the invention is thus a coating or composite moulding or mastic composition which comprises, in parts by weight:
A) 100 parts of at least one organic binder, which may or may not be reactive
B) 0.001 to 20, preferably 0.01 to 10 and more preferably 0.05 to 5 parts of at least one additive comprising cellulose microfibrils modified at the surface by at least one compound B1, the said cellulose microfibrils having an aspect ratio l/d (l being the length and d being the mean cross-section) of greater than 20 and a mean cross-section d ranging from 1 to 50 nm, the said compound B1 having:
   i) at least one hydrophilic part and at least one hydrophobic part, in the case of a modification by a physical route,
   ii) at least one hydrophobic part and a group which is reactive with regard to the surface functional groups of the cellulose microfibrils and more particularly with regard to the surface hydroxyl functional groups of the cellulose microfibrils, in the case of a modification by a chemical route
C) optionally, at least one organic diluent, which may or may not be reactive with regard to the organic binder A
D) optionally, up to 300 parts, preferably, where it is present, from 1 to 300 parts, more preferably from 1 to 200, of at least one component chosen from fillers such as calcium carbonate, talc or silica, inorganic fibres such as C fibres or organic fibres such as polyamides, and more particularly glass beads or fibres, pigments, dyes and other conventional additives, such as levelling agents, wetting agents, dispersants and surfactants, antioxidants, oxidizing agents, UV stabilizers, biocides, and the like. In the case of presence of dispersants or surfactants, these should be selected in such a way to avoid any antagonist effect against the adsorption of compound B1.

The physical route of modification may be more preferably the physical adsorption route at the microfibril surface, this route being preferred for its simplicity and lower process cost.

The microfibrils before modification can be obtained by various processes already disclosed in the literature. Reference may be made, among these processes, for example, to the processes disclosed in EP 726 356 and EP 1 114 065, the teachings of which are incorporated below.

The microfibrils may thus be obtained, starting from the plant pulp, such as, for example, beet pulp, by a process comprising the following steps:
first acidic or basic extraction, on completion of which a first solid residue is recovered,
   a) optionally, second extraction of the first solid residue carried out under alkaline conditions, following which a second solid residue is recovered,
   b) washing of the first and of the second solid residue,
   c) optionally, bleaching of the washed residue,
   d) dilution in water of the third solid residue obtained in stage d), so as to obtain a dry matter level of between 0.5 and 10%, preferably between 0.5 and 5% by weight,
   e) homogenization of the dilute suspension obtained in stage e).

In the case wherein these microfibrils are prepared from paper pulp, then, the process starts from step e) only.

In stage a), the term “pulp” is understood to mean pulp which is wet, dehydrated, preserved by ensilage, or partially depectinated.

The extraction stage a) can be carried out in an acidic or basic medium.

For an acidic extraction, the pulp is suspended in a solution of water for a few minutes so as to homogenize the suspension acidified to a pH between 1 and 3, preferably between 1.5 and 2.5, with a concentrated solution of an acid, such as hydrochloric acid or sulphuric acid.

This stage can be advantageous in removing the calcium oxalate crystals which may be present in the pulp and which, because of their high abrasive nature, can cause difficulties in the homogenization stage.

For a basic extraction, the pulp is added to an alkaline solution of a base, for example sodium hydroxide or potassium hydroxide, with a concentration of less than 9% by weight, preferably less than 6% by weight and more preferably still of between 1 and 2% by weight. A small amount of a water-soluble antioxidant, such as sodium sulphite Na₂SO₃, can be added in order to limit the oxidation reactions of the cellulose.

Stage a) is generally carried out at a temperature of between approximately 60 and 100° C. and preferably between 70 and 95° C.

The duration of stage a) is between 1 hour and 4 hours.

During stage a), partial hydrolysis occurs with release and dissolution of most of the pectins and hemicelluloses, while retaining the molecular mass of the cellulose.

The solid residue is recovered from the suspension originally from stage a) by employing known methods. Thus, it is possible to separate the solid residue by centrifuging, by filtration under vacuum or under pressure, with filter cloths, or, for example, filter presses, or by evaporation.

The first residue obtained is optionally subjected to a second extraction stage carried out under alkaline conditions.

A second extraction stage, stage b), is carried out when the first has been carried out under acidic conditions. If the first extraction has been carried out under alkaline conditions, the second stage is only optional.

According to this process, this second extraction is carried out with a base preferably chosen from sodium hydroxide and potassium hydroxide, the concentration of which is less than 9% by weight, preferably between 1% and 6% by weight.

The duration of the alkaline extraction stage is between 1 hour and 4 hours, preferably close to 2 hours.

On conclusion of this second extraction, if it takes place, a second solid residue is recovered.

In stage c), the residue originating from stage a) or b) is washed copiously with water in order to recover the cellulose material residue.

The cellulose material from stage c) is subsequently optionally bleached, in stage d), according to conventional methods. For example, it is possible to carry out a treatment with sodium chlorite, with sodium hypochlorite or with hydrogen peroxide in a proportion of 5-20% by weight with respect to the amount of dry matter treated.

Various concentrations of bleaching agent can be used, at temperatures of between 18 and 80° C. and preferably between 50 and 70° C.

The duration of this stage d) is between 1 hour and 4 hours and preferably between 1 hour and 2 hours.

A cellulose material comprising between 85 and 95% by weight of cellulose is then obtained.

On conclusion of this bleaching stage, it may be preferable to wash the cellulose copiously with water.

The resultant suspension, optionally bleached, is subsequently rediluted in water in a proportion of 0.5 to 10%, more preferably 0.5 to 5% of dry matter (stage e)), before undergoing a homogenization stage (stage f)) comprising at least one cycle.

The homogenization stage corresponds to a mixing, milling or any operation possessing high mechanical shearing, followed by one or more passes of the suspension through an orifice with a small diameter, in which the suspension is subjected to a fall in pressure of at least 20 MPa and to a high-speed shear action, followed by a high-speed deceleration impact.

The mixing or milling is, for example, carried out by one or more passes in the mixer or mill for a time ranging from a few minutes to 1 hour, in a device of the Waring Blender type equipped with a four-bladed propeller or edge runner or any other type of mill, such as, for example, a colloid mill.

The homogeneization itself will advantageously be carried out in a homogenizer of the Manton Gaulin type in which the suspension is subjected to a shear action at high speed and at high pressure, through a narrow gap and against an impact ring.

Mention may also be made, as homogenizer, of the Micro Fluidizer, which is mainly composed of a compressed air motor which will create very high pressures, of an interaction chamber in which the homogenization operation will be carried out (elongational shear, impacts and cavitations) and of a low-pressure chamber which makes possible the depressurization of the dispersion.

The suspension is introduced into the homogenizer, preferably after preheating to a temperature of between 40 and 120° C., preferably between 85 and 95° C. The homogenization operation is carried between 95 and 120° C. and preferably lower than 100° C. and more preferably less than 80° C. at pressures of between 20 and 100 MPa and preferably greater than 50 MPa, by a number of successive passes which can vary from 1 to 20 and preferably from 5 to 15, until a stable suspension is obtained.

The homogenization operation can advantageously be followed by a high mechanical shearing operation, for example in a device such as the UltraTurrax from Silverson.

The cellulose microfibrils are extracted by the mechanical route until pratically none of the starting fibres is visible by optical microscopy. The efficiency of this stage may be also monitored by the decrease in the size of the particles as measured by laser particle size determination.

The cellulose microfibrils which can be used according to the present invention have an aspect ratio l/d of greater than 20, preferably greater than 50 and more preferably still greater than 100, with a mean cross-section d ranging from 1 to 50 nm, preferably from 2 to 20 nm and more preferably still from 5 to 15 nm.

The cellulose microfibrils according to the invention originate from plant cellulose sources, such as wood, cotton, flax, ramie, certain algae, jute, sugarbeet pulp, citrus fruits, such as lemons, oranges or grapefruit, or waste from the food-processing industry, or from bacterial cellulose sources or from animal origine such tunicier (French name).

More particularly, the cellulose microfibrils are wood cellulose microfibrils preferably obtained from paper pulp and more preferably from paper pulp obtained according to a pulping process of kraft type or a bisulphite pulping process or sugarbeet pulp (also named beet pulp in this description).

The modified cellulose microfibrils which can be used according to the invention exhibit the aptitude of being easily redispersible in an organic medium either polar or non polar.

As regards the compound B1, it is preferably soluble in the organic binder A and/or the organic diluent C. Preferably, B1 is relatively soluble in order to avoid its desorption in the organic medium.

The term “soluble” means a homogeneous and transparent solution resulting from the mixing of the compound B1 with the organic binder A and/or the organic diluent C.

As regards the treatment of the cellulose microfibrils, the latter are modified at the surface either by a chemical route or by a physical route, the latter being preferred, as already mentioned above.

The cellulose microfibrils modified by a chemical route can be modified by various processes already disclosed in the literature. Reference may be made, among these processes, to the process disclosed in EP 1 114 065.

The chemical modification of the surface of the cellulose microfibrils can be obtained by various possible reactions of the surface functional groups of the cellulose microfibrils and more particularly of the hydroxyl functional groups with a compound B1 as defined above in ii), such as, for example, by:
silylation reactions,
etherification reactions,
condensations with isocyanates,
alkoxylation reactions with alkylene oxides,
condensation or substitution reactions with glycidyl derivatives.

The preferred organic compounds for chemical modification which react with hydroxyl functional groups are chosen from silylating agents, isocyanates, halogenated alkylating agents, alkylene oxides and/or glycidyl derivatives. This modification by chemical reaction results in a surface of the cellulose microfibrils with a predominant hydrophobic nature.

The cellulose microfibrils can also be modified by a physical route, either by adsorption at the surface, or by spraying, or by coating, or by encapsulation of the microfibril.

The preferred modified microfibrils according to the invention can be obtained by physical adsorption of at least one compound B1 as defined above and more preferably still of at least one compound B1 as defined above in i).

The expression “predominant hydrophobic nature” means that the compound B1 has a solubility in water which is markedly less than that in an organic binder A and/or an organic diluent C, however it is hydrodispersible in water.

The compounds of B1 type as defined in i) have at least one hydrophilic part and at least one hydrophobic part and may be compounds of low molecular weight Mw or compounds of higher molecular weight (Mn), such as macromolecular compounds having a molecular mass which can range up to 50 000 and more preferably still up to 20 000, for example ethylene oxide/propylene oxide block copolymers or other graft copolymers such as obtained from the copolymerisation of at least (meth)acrylic acid or maleic anhydride with a macromonomer with hydrophobic character such as a (meth)acrylate of C₁₂-C₂₄ alcohol and/or a macromonomer with hydrophilic character such as (meth)acrylate of polyethylene glycol or polypropylene glycol or of mixture of the said glycols, star(co)polymers or dendrimers or block copolymers or statistical copolymers such as styrene (meth)acrylic acid or styrene-maleic anhydride (SMA), which may be partly esterified or amidified by respectively fatty alcohols or amines having fatty chain length in C₁₂-C₂₄ or imidized under the imide form of SMA or its derivatives such as quaternary ammonium salts of SMA imide.

According to a more particular embodiment of the invention, the said compound B1 as defined above in i) comprises at least one surfactant, preferably a surfactant chosen from the group consisting of at least one anionic surfactant or at least one cationic surfactant or at least one amphoteric surfactant or at least one nonionic surfactant, it being possible for the latter to be in binary combination with each of the other three surfactants, and the said compound B1 as defined in i) more preferably still comprising at least one nonionic surfactant in combination with at least one anionic surfactant.

In the case where the said compound B1 as defined in i) comprises a surfactant, the latter can more particularly comprise:
a water-soluble hydrophilic part, preferably bearing oxyethylene units, capable of being adsorbed at the surface of the cellulose microfibrils as defined according to the invention,
a hydrophobic part, which has a pronounced chemical affinity with the organic binder A and/or the organic diluent C as defined according to the invention, and which comprises, for example, an aromatic or aliphatic or cycloaliphatic or mixed C₆ or longer carbon chain, and which is capable of interacting with the organic binder A and/or the organic diluent C as defined according to the invention.

In addition to the said compound B1, a cosurfactant or codispersant may be present in combination with B1, selected from: glycerol, Dowanol or polypropylene glycol. This cosurfactant may act as a plasticizer for the microfibrils.

The expression “hydrophobic part which is capable of interacting with the organic binder A and/or the organic diluent C” means that the said part is chemically compatible with the organic diluent C within the meaning of the solubility parameters.

Thus, the chemical compatibility between two compounds can under some conditions be estimated from the difference in the solubility parameters δ, which difference should not, according to this estimation, exceed 3 units for δ expressed in calories^{1/2}/cm^{3/2}.

Mention may be made, among the nonionic surfactants suitable for the invention, of castor oil derivatives ethoxylated with 30 to 40 EO (EO means an ethylene oxide unit) and more particularly hydrogenated castor oil derivatives ethoxylated with 7 to 60 EO, ethoxylated derivatives of coconut oil, soybean lecithin, polyethoxylated (8 to 30 EO, preferably 15 to 30 EO) C₆ to C₂₂, preferably C₈ to C₂₂ more preferably C₁₀ to C₂₂ fatty alcohols (even more preferred C₁₀ to C₂₂ with 15 to 30 EO), such as Tergitol 15S20 (C₁₃, 20 EO) more particularly said Tergitol in combination with Rhodafac® RS 610 even more particularly in a weight ratio Rhodafac® to Tergitol ranging from 99/1 to 25/75, more preferably 75/25 to 40/60 and even more preferably in the range of ±10% around 1/1 w/w, polyethoxylated alkylphenols, ethoxylated arylphenols, such as ethoxylated (8 to 30 EO, preferably 8 to 25 EO) di- or tristyrylphenol, tridecyl alcohol polyglycol ethers, such as ethoxylated tridecyl alcohol comprising 60 EO (Genapol® X-060 from Clariant), block polyethers of bi- and triblock type (Pluronic®, more particularly Pluronic® F127 or Poloxamer® 407 or Lutrol® F127 of more particular formula : (EO)₁₀₁-(PO)₅₆-(EO)₁₀₁ from BASF), sorbitol derivatives comprising 1 to 3 polyoxyethylene chains and 1 to 3 C₁₂ to C₃₀, in particular C₁₈, fatty chains, such as polyoxyethylene sorbitan trioleate such as Tween® 85 (polyoxyethylene sorbitan trioleate with 20 EO), C₈ to C₂₆ fatty acid esters ethoxylated with 8 to 25 EO, fatty acid derivatives, mono- and diglyceride esters of C₈ to C₃₆ fatty acids, and C₈ to C₂₂ fatty amines, such as dodecylamine, or mixtures.

Mention may be made, among anionic surfactants suitable for the invention, of the following families: alkyl sulphates, alkyl ether sulphates, alkoxylated fatty alcohol sulphates, alkanolamide sulphates, glyceride sulphates, alkyl phosphates, alkyl ether phosphates, alkoxylated fatty alcohol phosphates, alkylbenzenesulphonates, such as dodecylbenzenesulphonate, lignosulphonates, dialkyl sulphosuccinates,alkyl diphenyl oxyde disulphonate such as Dowfax® D2A1 from Dow, sarcosides, acylamino acids, monoglyceride esters of tartaric acid, or monoglyceride esters of citric acid.

Mention may also be made, as anionic surfactants which are preferred for the invention, of sulphate esters (partial esters of sulphuric acid with the corresponding fatty alcohol) such as Disponil® FES7715 (C₁₂, 30 EO) or Disponil® FES 993 (C₁₂, 9 EO) from Cognis or Dowfax® D2A1 from Dow, or phosphate esters (partial mono- or diesters of phosphoric acid with the corresponding fatty alcohol, preferably C₆ to C₂₂ fatty alcohols, with 2 to 30 oxyalkylene units, preferably with 3 to 6 oxyalkylene units (Rhodafac® from Rhodia Chimie more particularly Rhodafac® RS610-phosphate of C₁₃, 6 EO alcohol as aqueous 25% solution from Rhodia Chimie—or Servoxyl® VPDZ 20/100—phosphate of C₁₃, 20 EO alcohol, Servoxyl® VPNZ 20/30—phosphate of nonyl phenol 20 EO, or Servoxyl® VDPZ 100—phosphate of C₁₃ alcohol from Elementis), such as phosphate esters of oleyl fatty alcohol which are ethoxylated with 2 EO (Empiphos® O3D from Albright & Wilson), phosphate esters of oleyl alcohol which are ethoxylated (Crodafos® N from Croda Oleochemicals), phosphate esters of cetearyl alcohol which are ethoxylated with 2 to 10 EO (Crodafos® CS from Croda Oleochemicals), phosphate esters of tridecyl alcohol which are ethoxylated with 4 to 6 EO (Emphos® PS from CK Witco), phosphate esters of fatty alcohol which are ethoxylated (Crafol® AP from Henkel Iberica), ethoxylated arylphenol sulphate esters, such as ethoxylated di- or tristyrylphenol (Soprophor DSS/7 and Soprophor 4D384 from Rhodia Chimie), simple or mixed organic phosphate acid esters (Beycostat® from Ceca S.A., such as, for example, Beycostat® A B09, also known under the common name of BNA), polyalkoxylated alkylphenol phosphate esters, the alkyl substituent of which is a C₁ to C₁₂ alkyl substituent, with 5 to 25 oxyalkylene units, the said oxyalkylene unit being a C₂ to C₄ oxyalkylene unit, arylphenol phosphate esters with 5 to 25 EO, such as the ethoxylated di- or tristyrylphenol phosphate ester (Soprophor 3D33 from Rhodia Chimie), or partially neutralized polycarboxylic acid salts, such as the sodium and potassium salts.

Anionic surfactants which are even more preferred for the invention are, for example:
i) a polyalkoxylated alkylphenol phosphate ester, the alkyl substituent of which is a C₂ to C₈ alkyl substituent and the oxyalkylene of which is a C₂ oxyalkylene, or
ii) a simple organic phosphate acid ester or an organic phosphate acid ester as a specific mixture: Beycostat® A B09, also known under the common name BNA, a mixture of ester and of diester of phosphoric acid comprising an alkylaryl chain, the alkyl substituent of which is a C₉ alkyl substituent, with 9 oxyethylene units.
iii) Rhodafac® RS 610
iv) Disponil® FES 993

The monoester and diester of phosphoric acid present in BNA are: monoester of phosphoric acid with nonylphenol which has been ethoxylated nine times, and the corresponding diester. Their formulae are given below:
monoester: C₉H₁₉—C₆H₄—O—(CH₂—CH₂—O)₉P(O)(OH)₂
diester: (C₉H₁₉—C₆H₄—O—(CH₂—CH₂—O)₉)₂P(O)(OH)

Even more preferred surfactants may comprise combinations of at least one of the said anionic surfactants such as said ethoxylated phosphates or sulphates with at least one of the said non ionic surfactants such as said polyethoxylated fatty alcohols. For example, the said phosphate may be Rhodafac® RS 610 and the said sulphate may be Disponil® FES 993 in combination with an ethoxylated (preferably 15 to 30 EO) fatty alcohol (preferably C₁₀ to C₂₂) such as Tergitol 15S20 with a weight ratio of the said phosphate or of the said sulphate to the said ethoxylated fatty alcohol ranging from 99/1 to 25/75, preferably from 75/25 to 40/60 and more preferably in the range of ±10% around 1/1 weight ratio.

Mention may be made, among cationic surfactants which are suitable for the invention, of alkyl quaternary ammonium salts derived from C₆ to C₂₀ fatty amines and comprising 1 to 2 alkyl substituents, such as didecyldimethylammonium bromide, amide salts, salts of esters and of ether amines, salts of oxy- and ethoxyamines, alkanolamide salts or imide salts, Servamine KW100 from Elementis (sulfate of alkyl bis hydroxy ethyl methyl quaternary ammonium with 15 EO units).

Mention may be made, among amphoteric surfactants suitable for the invention, of compounds possessing a quaternary ammonium group and an anionic phosphoric group, such as the family of the phospholipids, or aliphatic secondary or tertiary amine derivatives, in which the aliphatic radical is a linear or branched C₈ to C₂₂ chain, comprising at least one water-soluble anionic group, such as carboxylates, sulphonates, sulphates, phosphates or phosphonates. Mention may also be made of C₈ to C₂₀ alkyl betaines, sulphobetaines, C₈ to C₂₀ alkyl amido (C₁ to C₆)alkyl betaines, or C₈ to C₂₀ alkyl amido (C₁ to C₆) alkyl sulphobetaines.

Other surfactants with a pronounced hydrophobic nature can also be used, such as, for example, silicone-comprising surfactants and fluorosurfactants.

Mention may be made, as an example of a process for treatment by physical adsorption, of the process disclosed in FR 2 794 762. This process comprises the following stages:
a′) mixing an aqueous dispersion of cellulose microfibrils with at least one compound B1 as defined in i), ajustment of pH when necessary (for example if phosphate surfactant used at pH 8) which may be done in the surfactant or in the microfibrils dispersion itself.
b′) removing the water from the aqueous dispersion in order to obtain a dry mixture of cellulose microfibrils and of the compound B1 as defined in i) above.

The water is removed by thermal drying at a temperature not exceeding 100° C. preferably less than 80° C. or by infrared or by atomization or by solvent exchange or lyophilisation.

During stage a′), the compound B1 as defined in i) is mixed, preferably with simple stirring, with an aqueous dispersion of cellulose microfibrils (0.5 to 20%, preferably 1 to 15% w/w) having the characteristics defined according to the invention.

The proportions of compound B1 and of cellulose microfibrils before modification can depend on the source of the cellulose microfibrils and more particularly on their specific surface. A boundary ratio by weight of the compound B1 to cellulose microfibrils before modification can be defined as corresponding to the flocculation threshold of the said dispersion of microfibrils when redispersed in the organic solvant. This boundary ratio, depending on the origin of microfibrils, is less than 1, more particularly less than 0.5 and more particularly for the compound B1 physically adsorbed as defined in i).

The ratio by weight of the compound B1, and more particularly of the compound B1 as defined in i), to cellulose microfibrils as such can be chosen within the range from 0.5/1 to 10/1, preferably from 1/1 to 10/1 and more preferably from 1.5/1 to 5/1 and more preferably 2/1 to 5/1.

The said modified cellulose microfibrils according to the invention are obtained by drying an aqueous dispersion of cellulose microfibrils as defined according to the invention comprising a level of said modified cellulose microfibrils by weight ranging from 1 to 40% preferably 4 to 40%, preferably from 10 to 40% with respect to the said dispersion, the said compound B1 being present according to a ratio as defined above of compound B1 to cellulose microfibrils.

The additive B can be obtained either in the form of a fine powder, by milling, or in the form of an elastic pregel in an organic binder A and/or an organic diluent C as defined according to the invention, or in the form of solid granules with a controlled particle size.

The said organic binder A according to the said composition of the invention can first be reactive and selected from: epoxy/amines or more particularly epoxy-polyamide starting from crosslinkable two-component systems, unsaturated polyesters, vinyl esters, modified alkyds, for example modified by acrylic or urethane or styrene alkyds, or unmodified alkyds, polyurethanes starting from crosslinkable two-component systems, and more particularly acrylic polyurethanes starting from crosslinkable two-component systems such as polyisocyanate and hydroxylated acrylic resins or hydroxylated polyesters or melamine/hydroxylated acrylic resin or hydroxylated polyester resin, acrylated acrylic oligomers, binders which can be crosslinked thermally or under UV and/or EB radiation, silanized polyethers modified with alkoxysilanes, or silanized polyurethanes modified with alkoxysilanes.

The said organic diluent C according to the said composition of the invention can be reactive or non-reactive according to the organic binder A, with a level by weight, per 100 parts of organic binder A, which can vary according to the following situations:
for a reactive diluent C, up to 300, preferably up to 200 parts by weight,
for a non-reactive diluent, up to 100 parts by weight.

The first role of this organic diluent C is to be a solvent for the organic binder A. More particularly, the organic binder A can be a nonreactive binder, such as a linear polymer, which is soluble in an organic diluent of C type. Mention may be made, as examples of such polymers, of polyurethanes, polyacrylates, elastomers of SBR type, polychloroprene or butyl rubber.

The organic diluent C can be an organic solvent or a plasticizer, and it is chosen according to the type of organic binder A used.

For an organic binder A selected from unsaturated polyesters, vinyl esters or acrylated acrylic oligomers, the organic diluent C can be chosen from (meth)acrylic and/or allyl and/or vinylaromatic monomers, the vinylaromatic monomers preferably being styrene and derivatives, including vinyltoluenes.

For a non-reactive organic binder A selected from soluble linear polymers, such as polyurethanes, thermoplastic acrylic resins (polyacrylates), elastomers of SBR type, polychloroprene or butyl rubber, the organic diluent C is also nonreactive and can be chosen from aromatic solvents, ketones, alkanes, petroleum ethers, alcohols, alkyl acetates, white spirit or their mixtures, preferably xylenes, toluene, acetone, ethyl acetate, isopropyl acetate, methyl ethyl ketone, hexane, dimethyl sulphoxide, dichloromethane, trichloroethylene or methylene chloride.

Where the organic binder A is a reactive bi-component system, it may be selected from epoxy/amine reactor systems which can comprise at least one epoxy resin, comprising at least 2 epoxy groups, and at least one amine or polyamide compound, comprising at least 2 amine groups, polyurethane systems which can comprise at least one polyisocyanate and at least one polyol, polyol/melamine systems, or epoxy/carboxylic acid or anhydride polyester systems or polyol/carboxylic acid or anhydride polyester systems which can comprise at least one epoxy or polyol and at least one corresponding carboxylic acid or anhydride, the organic diluent C can be chosen, for these two-component systems, from: aromatic hydrocarbons, primary, secondary or tertiary alcohols, in particular those comprising an aliphatic chain and/or an aromatic chain, ketones, glycol ethers, alkyl acetates, white spirit or their mixtures, preferably xylenes, n- and iso-butanol, ethyl acetate, butyl acetate, 1-methoxy-2-propyl acetate, methyl isobutyl ketone, methyl ethyl ketone, butyl glycol or N-methylpyrrolidone.

For an organic binder A selected from alkyds, which may be modified, for example acrylic, urethane or styrene alkyds, or unmodified alkyds, the organic diluent C can be chosen from aromatic solvents, petroleum, ketones, alkanes, alkyl acetates, white spirit or their mixtures, preferably xylenes, white spirit, butyl acetate, heptane, methyl isobutyl ketone or methyl ethyl ketone. More particularly for acrylic thermoplastic resins (polyacrylates), the solvant C may be selected from: aromatic hydrocarbons, primary, secondary or tertiary alcohols particularly those bearing aliphatic and/or aromatic chain, ketones, glycol ethers, alkyl acetates, white spirit or their mixtures, preferably xylenes, toluene, n- or iso-butanol, ethyl and butyl acetate or 1-methoxy-2 propanol acetate, methyl isobutylketone.

For an organic binder A selected from binders which can be crosslinked thermally or under UV and/or EB radiation and selected from (meth)acrylic oligomers or acrylated acrylic oligomers or allylic oligomers which are multifunctional, the organic diluent C can be chosen from (meth)acrylic and/or allylic and/or vinylaromatic monomers.

For an organic binder A selected from silanized polyethers or silanized polyurethanes, the organic diluent C can be a plasticizer chosen from phthalates, benzoates, glycols or their mixtures, preferably diisobutyl phthalate, diisoundecyl or diisodecyl phthalate or polyether glycol.

A first type of composition according to the invention is a coating composition and more particularly a leaktightness coating.

A first type of coating composition according to the invention can comprise at least one organic binder A selected from unsaturated polyesters or vinyl esters or acrylated acrylic oligomers and at least one organic diluent C selected from (meth)acrylic and/or allylic and/or vinylaromatic monomers, the vinylaromatic monomers preferably being styrenes and derivatives, including vinyltoluenes. A more particular case of the above coating composition can be a pigmented or nonpigmented gel coat.

Another particular case of a coating composition according to the invention can be an adhesive in an organic solvent medium comprising at least one organic binder A which can be a linear polymer soluble in at least one nonreactive organic diluent C. Such organic binders A can be soluble linear polymers, such as polyurethanes, polyacrylates, elastomers of SBR type, polychloroprene or butyl rubber. The nonreactive organic diluents C can be aromatic solvents, ketones, alkanes, petroleum ethers, alcohols, alkyl acetates, white spirit or their mixtures, preferably xylenes, toluene, acetone, ethyl acetate, isopropyl acetate, methyl ethyl ketone, hexane, dimethyl sulphoxide, dichloromethane or trichloroethylene.

Another possible type of coating composition according to the invention can be a composition based on a reactive organic binder A comprising:
at least one organic binder A selected from the following crosslinkable two-component reactive systems: epoxy/amine or epoxy/polyamide systems comprising at least one epoxy resin, comprising at least 2 epoxy groups, and at least one amine compound, comprising at least 2 amine groups, polyurethane systems comprising at least one polyisocyanate and at least one polyol, polyol/melamine systems, and polyester systems based on at least one epoxy or one polyol which reacts with at least one corresponding carboxylic acid or anhydride,
at least one organic diluent C which is nonreactive with regard to organic binder A, selected from the following solvents: aromatic hydrocarbons, primary, secondary or tertiary alcohols, in particular those comprising an aliphatic chain and/or an aromatic chain, ketones, glycol ethers, alkyl acetates, white spirit or their mixtures, preferably xylenes, butanol, ethyl acetate, butyl acetate, 1-methoxy-2-propyl acetate, methyl isobutyl ketone, methyl ethyl ketone, butyl glycol or N-methylpyrrolidone.

In the case of a crosslinkable two-component polyurethane system (polyisocyanate/polyols) or of a polyester system based on epoxy/acid or polyol/acid or polyol/melamine, the polyol can preferably be a hydroxylated acrylic resin obtained, for example, by copolymerization of an acrylic monomer such as alkyl acrylate with an hydroxylated acrylic monomer, such as a hydroxyalkyl(meth)acrylate.

Another coating composition according to the invention can comprise at least one organic binder A selected from modified alkyds, for example acrylic, urethane or styrene alkyds, or unmodified alkyds, and at least one organic diluent C selected from aromatic solvents, petroleum, ketones, alkanes, alkyl acetates or their mixtures, preferably xylenes, butyl acetate, white spirit, heptane, N-methylpyrrolidone, methyl isobutyl ketone, methyl ether ketone or their mixtures.

Another possible coating composition according to the invention can comprise at least one organic binder A which can be crosslinked thermally or under UV and/or EB radiation and which is selected from (meth)acrylic oligomers or acrylated acrylic oligomers or allylic oligomers which are multifunctional, having a functionality at least equal to 2, and at least one organic diluent C selected from (meth)acrylic and/or allylic and/or vinylaromatic monomers.

Another possible composition according to the invention is a mastic composition, which can comprise:
at least one organic binder A selected from unsaturated polyesters, vinyl esters, silanized polyethers or silanized polyurethanes, or other polyurethanes
at least one organic diluent C selected from (meth)acrylic and/or allylic and/or vinylaromatic monomers, the vinylaromatic monomers being such as styrene and derivatives, including vinyltoluenes, aromatic hydrocarbons, white spirit or their mixtures, if the organic binder A selected is an unsaturated polyester or a vinyl ester, and, if the organic binder A is a silanized polyether or a silanized polyurethane, the organic diluent C is a plasticizer chosen from phthalates, benzoates, glycols or their mixtures, preferably diisobutyl phthalate, diisoundecyl or diisodecyl phthalate or polyether glycol.

Another composition according to the invention can be a composite moulding composition, the term moulding having the meaning defined above, which can comprise, in addition to the additive B as defined according to the invention, at least one organic binder A selected from unsaturated polyesters, vinyl esters, crosslinkable two-component epoxy/amine systems or crosslinkable two-component polyurethane systems (polyisocyanate/polyol).

The moulding compositions according to the invention can comprise compositions of SMC type or lamination compositions, in particular for boat construction or composite panels, with application of the composition either by spraying with a gun or with a brush or with a roller. The thixotropic effect of such compositions according to the invention makes it possible to obtain a satisfactory compromise between the impregnation of the fibres (sufficiently low viscosity to apply and impregnate) and the prevention of sagging (sufficiently rapid increase of viscosity to avoid creep/sagging).

The second subject-matter of the invention is the specific process for the preparation of the said compositions according to the invention. This specific process comprises at least one stage of mixing at least one additive B with at least one organic binder A and/or at least one organic diluent C.

According to a more particular form of this process, the mixing takes place with shearing, with the additive B introduced in the form of a powder or in the form of an intermediate preconcentrated composition comprising it.

More particularly, the intermediate composition can be in the form of powder or of an elastic pregel or of solid granules with a controlled particle size ranging from 0.5 to 20 mm. These different supply forms facilitate the use of the coating or composite moulding or mastic compositions according to the invention by simple dispersion with shearing, without any need for thermal activation.

An alternative form of this process consists in adding at least one additive B before and/or after the addition of the component D, in the case of the presence of a component D as defined above.

The third subject-matter of the invention relates to the use of the composition defined according to the invention in compositions for paints, varnishes, gel coats, inks, adhesives in a solvent medium, leaktightness agents, composite moulding or mastics.

The coating compositions according to the invention may be used as protective and/or decorative and/or surface treatment coatings (cleaning and stripping) for various substrates.

The final subject-matter of the invention relates to an intermediate composition which can be used for the preparation of a composition as defined according to the invention or obtained according to the process defined according to the invention, comprising at least one additive B at a concentration by weight ranging from 2 to 50%, preferably 5 to 50% and more preferably from 5 to 25% and more particularly 10 to 25%, with respect to the total weight of the said composition, and comprising at least one organic binder A and/or at least one organic diluent C according to the definition of the invention above.

An alternative form of this intermediate composition may comprise at least one organic diluent C, without any organic binder A. This intermediate composition is particularly suitable for coating or moulding or mastic compositions comprising up to 300, preferably up to 200 parts by weight of a reactive organic diluent C, for 100 parts of an organic binder A, or up to 100 parts by weight of a nonreactive organic diluent C, per 100 parts by weight of an organic binder A.

In this type of intermediate composition (organic diluent C alone), the organic diluent C is selected from (meth)acrylic and/or allylic and/or vinylaromatic monomers, the vinylaromatic monomers being such as styrene and derivatives, aliphatic solvents, cycloaliphatic solvents, such as cyclohexane, aromatic solvents, such as toluene or xylenes, white spirit, ketones, primary, secondary or tertiary alcohols, in particular polyalcohols or alcohols comprising an aliphatic chain and/or an aromatic chain, such as butanol or isopropanol, C₁ to C₄ alkyl esters, such as ethyl acetate, glycol esters, plasticizers, such as phthalates or benzoates or glycols, or their mixtures.

Another alternative form of this composition is an intermediate composition comprising at least one organic binder A and at least one organic diluent C.

Another possible case is that where at least one liquid organic binder A is used instead of the organic diluent C, in the absence of any organic diluent C. Such liquid binders can be chosen from (meth)acrylic oligomers which are liquid, vinyl esters, epoxy resins and other liquid resins which can act as organic binder A according to the invention.

The intermediate composition according to the invention preferably exists in the form of a powder or of an elastic pregel or of solid granules with a controlled particle size ranging from 0.5 to 20 mm which are readily dispersible in the final applicational formulation.

The examples below illustrate the invention without limiting the scope thereof:

Preparation of the Beet Cellulose Microfibrils MCBM1, MCBM3 and MCBM4 and MCBM7:

Microfibrils extracted from beet (sugar beet) are obtained starting from beet pulp: pulping is carried out in a basic medium (0.8 part of sodium hydroxide per 1 part of pulp) or an acidic medium (sulphuric acid at 85° C.), the purpose of the pulping being to separate the fibres and to extract the pectins. The effectiveness of this stage is monitored by the decrease in the infrared absorption spectrum in the region 1720 to 1770 cm⁻¹. The time required is several hours. One or more rinsings follow until the water obtained contains a very low load of ions and has a pH of between 5.5 and 7. After this stage, the release of the cellulose microfibrils is obtained by high disintegration of the cell walls in an aqueous medium. One means which can be used is a homogenizer of the Manton Gaulin type. For an initial concentration of fibres of 0.8%, a minimum pressure of 40 MPa (400 bar) is used for at least 50 minutes. The aqueous suspension is then treated by adding the surfactant Beycostat® A B09 from CECA S.A. (BNA), which is a mixture of ester and of diester of phosphoric acid comprising an alkylaryl chain, the alkyl substituent of which is a C₉ alkyl substituent, with 9 oxyethylene units, to the cellulose microfibrils, at pH=8, in a proportion by mass of 4 parts per 1 part by weight of cellulose microfibrils. The suspension is subsequently dried by evaporating the water in a ventilated oven or by any other effective means, such as drying under a stream of air or freeze drying.

Preparation of the Eucalyptus Cellulose Microfibrils MCBM9:

The starting material is an industrial paper pulp formed of long eucalyptus fibres, the pulp being obtained by the bisulphite chemical route using ammonium bisulphite. The release of the cellulose microfibrils is obtained by high disintegration of the cell walls in an aqueous medium. One means which can be used is a homogenizer of the Manton Gaulin type. For an initial concentration of fibres of 0.8%, a minimum pressure of 40 MPa (400 bar) is used for at least 50 minutes. The aqueous suspension is then treated by adding the surfactant Beycostate A B09 from CECA S.A. (BNA), which is a mixture of ester and of diester of phosphoric acid comprising an alkylaryl chain, the alkyl substituent of which is a C₉ alkyl substituent, with 9 oxyethylene units, to the cellulose microfibrils, at pH=8, in a proportion by mass of 4 parts per 1 part by weight of cellulose microfibrils. The suspension is subsequently dried by evaporating the water in a ventilated oven or by any other effective means, such as drying under a stream of air or freeze drying. The microfibrils thus obtained have a mean cross-section d of between 10 and 20 nm.

Preparation of the Pine (Coniferous) Cellulose Microfibrils MCBM10 to MCBM21:

The starting material is a chemical pulp formed of long fibres of bleached maritime pine (coniferous) which has been subjected to bisulphite cooking. This pulp is the reference Biofluff® HD from Tembec Tartas. The release of the cellulose microfibrils is obtained by high disintegration of the cell walls in an aqueous medium. One means which can be used is a homogenizer of the Manton Gaulin type. For an initial concentration of fibres of 1% to 1.5%, a minimum pressure of 40 MPa (400 bar) is used for at least 50 minutes or 10 passes of the suspension in the homogenizer.

The aqueous suspension is then treated by adding the surfactant (solution at 10% in water) to the cellulose microfibrils under agitation, in a proportion by mass of 4 parts of surfactant per 1 part by weight of cellulose microfibrils. The pH of the phosphated surfactant solutions is adjusted to 8 so that the surfactants are completely in ionic form. The suspension is subsequently dried by lyophilising (MCBM10 and 11) or by evaporating the water in a ventilated oven at 60° C. (MCBM 12 to 21) or by any other effective means. After preparation, MCBM12 to 21 are stored at least one day in a conditioned room (22° C., 50±10% RH).

It is noticed that the preparation of cellulose microfibrils resulting from wood is much faster than that of cellulose microfibrils resulting from sugar beet.

Measurement of the Parameters of the Microfibrils: Length 1, Mean Cross-Section d, Aspect Ratio l/d.

The size of the cellulose microfibrils is measured by atomic force microscopy (AFM). The modified microfibrils are diluted in xylene to 1% and then deposited on a cleaved mica slide. The solvent is allowed to evaporate naturally. The AFM images were obtained in tapping mode and the drive frequency is close to the resonance frequency of the tip. The region observed is a scare of 10×10 μm. The scan speed is 1 Hz and the number of scans is 512.

The results are collated in the following Table 1:

TABLE 1

| | Nature of | Nature of | Compound |
|---|---|---|---|
| Name of the | the | the compound | B1/microfibrils |
| product | microfibrils | B1 | ratio |
| MCBM1 | Beet | BNA | 4/1 |
| MCBM9 | Eucalyptus | BNA | 4/1 |
| MCBM10 | Pine | BNA | 4/1 |
| | (coniferous) | | |

| Name of the | Mean cross- | | Aspect ratio |
|---|---|---|---|
| product | section d | Length l | l/d |
| MCBM1 | 5-7 nm | >1 μm | >100 |
| MCBM9 | 8-12 nm | >1 μm | >100 |
| MCBM10 | 8-12 nm | >1 μm | >100 |

### EXAMPLE 1 (INVENTION)

### Application in a Two-Component Epoxy/Polyamine Paint

The remarkably effective nature of the cellulose microfibrils as thixotropic agent is demonstrated by evaluating them in two-component epoxy/polyamine paints. The cellulose microfibrils are used either in the form of a premilled (pre-grinded) powder or in the form of a pregel obtained by mixing 13% of dry cellulose microfibrils modified at the surface by at least one compound B1 and 87% of xylene.

The additive is dispersed in the xylene using an UltraTurrax homogenizer for at least 5 minutes, at ambient temperature and at a speed of 24000 revolutions/minute.

A millbase without thixotropic additive is prepared.

The formula of the paint appears in the following Table 2.

TABLE 2

| | | | |
|---|---|---|---|
| | | | Percentage |
| Raw materials used | Commercial references | Suppliers | by mass (%) |

MILLBASE

| | | | |
|---|---|---|---|
| Epoxy resin | Araldite GZ 7071X75 | Vantico | 17.3 |
| Epoxy resin | Araldite GY 783BD | Vantico | 12.9 |
| Air release agent | Byk A 530 | Byk Chemie | 0.5 |
| Dispersant | Disperbik 110 | Byk Chemie | 0.5 |
| White pigment, | RCL 535 or Tiona 395 | Millenium | 1.9 |
| TiO₂ | | | |
| Yellow pigment | Bayferrox 3920 | Bayer | 4.1 |
| Anticorrosion | ZP 10 | Henbach | 7.5 |
| pigment | | | |
| Filler, talc | Finntalc M05 | Omya | 9.4 |
| Filler, silica | HPF6 | Sibel Co | 19 |
| n-Butanol | Rectapur | Prolabo | 5.4 |
| Thixotropic additive | Modified cellulose | | x |
| | microfibrils | | |

CURING AGENT

| | | | |
|---|---|---|---|
| Reactive | Crayamid ® 140 | Cray Valley | 8.8 |
| polyamide | | | |
| terminated by | | | |
| amine functional | | | |
| groups | | | |
| Xylene | Carlo Erba | Prolabo | 11.9 |
| Total | | | 99.2 + x |
| Solids content by | | | 77.7% |
| weight | | | |
| Solids content by | | | 64.7% |
| volume | | | |
| CPV | | | 29.1% |
| Density | | | 1.36 |

The paints are treated, with as additives, different levels of cellulose microfibrils or with fatty acid diamides.

The additive is dispersed in the millbase in a Disperlux mill at a speed of 3000 revolutions/minute (55° C./20 min). The fatty acid diamide is activated according to the technical sheet of the supplier.

After waiting for 24 hours, the curing agent Crayamid® 140 from Cray Valley, and xylene are added to the dispersion, while shearing at 200 revolutions/minute, over 5 minutes and at ambient temperature.

The viscosity of the formulation is adjusted to 0.4 Pa.s with a xylene/butanol mixture with a ratio of 1/1, and a shear rate of 2500 s⁻¹.

Recovery of Viscosity of a Two-Component Epoxy/Polyamine Paint:

The viscosity recovery is evaluated with an SR 5000 rheometer.

A shear stress of 700 Pa is applied to the coating formulation at 23° C. for 60 seconds.

The viscosity of the formulation is subsequently measured under a constant stress of 1 Pa for 120 seconds, at 23° C. (this stress simulates the sagging of the paint film).

The viscosity recovery is related to the sag resistance of the paint.

The viscosity recovery of the beet cellulose microfibrils MCBM1 is compared with that of the fatty acid diamides.

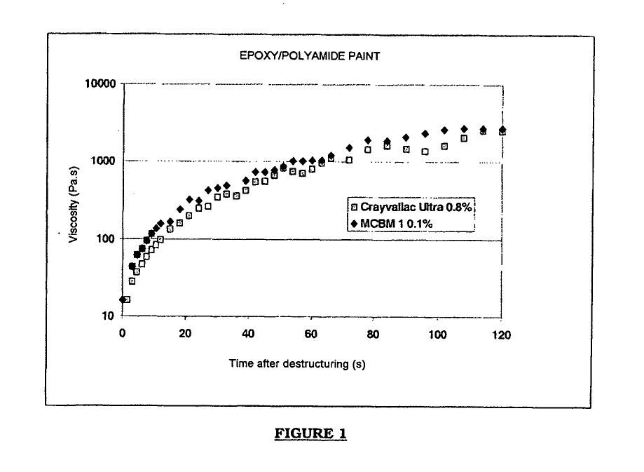

FIG. 1 shows that the beet cellulose microfibrils MCBM1 are as effective at a dosage of 0.1% as the fatty acid diamide Crayvallac Ultra® from Cray Valley S.A. at a dose of 0.8%. This dosage is conventional in this type of formulation.

The cellulose microfibrils make it possible to obtain a very effective sag resistance at much lower levels of active material than the fatty acid diamides, and without prior thermal activation.

Sag Resistance of a Two-Component Epoxy/Polyamine Paint:

The sag resistance is measured by a chart test on a Leneta chart. This test consists in depositing increasing thicknesses of paint on this chart. When two strips join, the maximum thickness of the wet film before sagging is given as sag resistance (method according to standard method ASTM D4400).

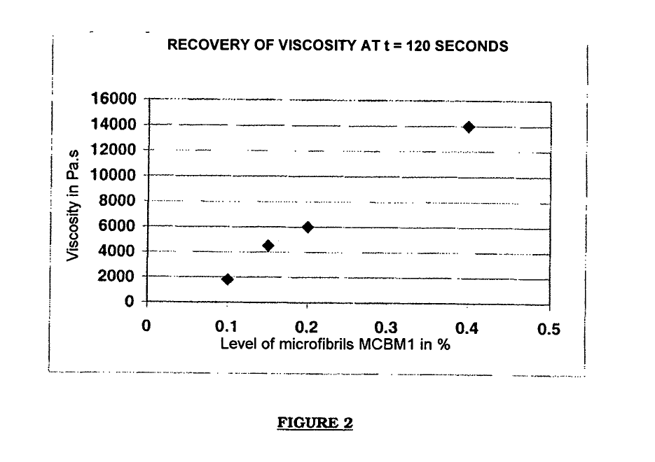

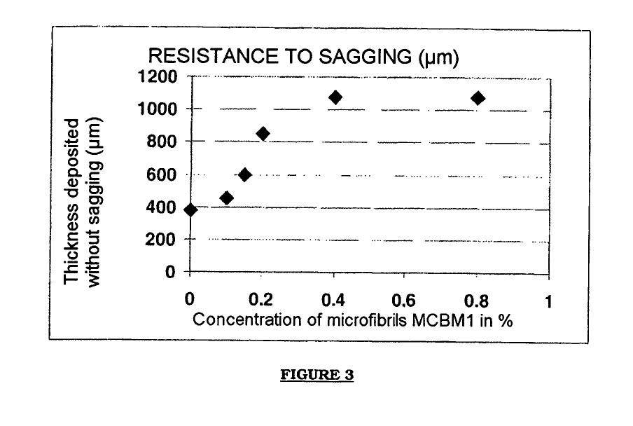

FIGS. 2 and 3 show that an increase in the dosage of beet cellulose microfibrils MCBM1 results in a considerable improvement in the sag resistance of the two-component epoxy/polyamine paints.

For FIG. 3, the sag-free thicknesses of greater than 1075 microns deposited could not be measured due to the lack of a suitable applicator. 1075 microns thickness as indicated means a sag resistance equal or superior to this value, given the limitation of the thickness in this test.

Intercoat Adhesion:

To evaluate the intercoat adhesion, a coat of epoxy/polyamine paint having a thickness after drying of between 70 and 80 μm is applied to a bichromated aluminium substrate (Q-Panel QAL46H24 with a thickness of 0.8 mm), degreased beforehand with ethyl acetate. This application is carried out with a Sheen applicator and the thickness of the dry paint coat is determined by an eddy current device.

The aluminium plate is subsequently placed vertically or horizontally in a chamber under an atmosphere saturated with xylene/butanol (50/50) solvents for 30 minutes (in the first test) and 96 hours (in the second and third tests). A second coat is then applied, the thickness of which after drying is between 70 and 80 μm.

Subsequently, at 9 days, a tear-off test is carried out and it is determined where delamination has taken place by measuring the thickness of the remaining paint. If the thickness lies between 70 and 80 μm, this means that delamination has taken place between the two coats of paint. If the remaining thickness is markedly less than 70 μm, this means that delamination is close to the substrate. The intercoat adhesion is then assessed as being very good.

The tear-off test is carried out by adhesively bonding a cylindrical contact with a diameter of 20 mm to the surface of the coating. The adhesive used is the reference adhesive 9323 B/A from 3M. The adhesive is left to dry at 23° C. for 24 hours. The thickness of adhesive is 100 μm and the surface area for adhesive bonding is 227 mm². The contact is torn off with a dynamometer and the remaining thickness is determined.

The results appear in the following Table 3:

TABLE 3

| | Thickness remaining | |
|---|---|---|
| Formulations | after tearing off | Intercoat adhesion |
| Intercoat adhesion | (μm) | quality |
| Epoxy paint with 0.4% of | 20 μm | Very good |
| MCBM1 on epoxy paint with | | |
| 0.4% of MCBM1 | | |
| Epoxy paint with 0.4% of | 20 μm | Very good |
| MCBM1 on epoxy paint with | | |
| 0.7% of Crayvallac Ultra ® | | |
| Epoxy paint with 0.4% of | 20 μm | Very good |
| MCBM1 on epoxy paint with | | |
| 0.7% of Crayvallac Super ® | | |

Even under very severe conditions, the beet cellulose microfibrils do not bring about delamination of the second coat of paint.
Stability of the Sag Resistance, Stability upon Storage at 50° C.:

Two millbases are manufactured using respectively 0.4% and 0.8% of MCBM10 as thixotropic agent. This base is divided into three equal portions. One portion is stored at 23° C. A second portion is stored at 50° C. for 7 days and a third portion is stored at 50° C. for 30 days. The second and the third portions of the base are cooled to ambient temperature. The curing agent as described in Table 2 is subsequently added to these 3 bases.

The results obtained for the two said millbases appear in the following Table 4:

TABLE 4

| | | Sag Resistance |
|---|---|---|
| Number of days in | Sag Resistance | 0.4% MCBM10 |
| an oven at 50° C. | 0.8% MCBM10 | (2 tests) |
| 0 | >1075 μm | 625-650 μm |
| 7 | >1075 μm | 700-725 μm |
| 30 | >1075 μm | 675-700 μm |

The resistance to sagging of the paints manufactured with the bases stored at 50° C. is not affected.

Comparison of the Different Natures of Microfibrils:

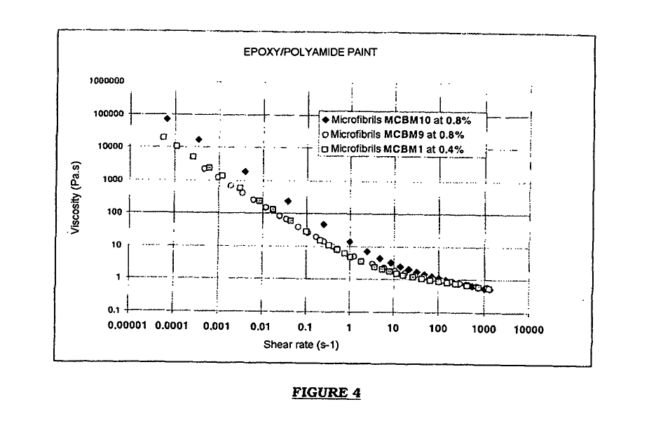

The flow curves of three epoxy/polyamine paints to which have been added cellulose microfibrils resulting from beet MCBM1 (0.4%) or from eucalyptus MCBM9 (0.8%) or from pine (coniferous) MCBM10 (0.8%) are compared in FIG. 4.

The microfibrils of sugar beet are more efficient than those obtained from trees (factor 2 higher).

It is also advantageous to note that the microfibrils resulting from pine (coniferous) are considerably easier to obtain than those resulting from beet.

Influence of the Compound B1/Cellulose Microfibrils Ratio:

Cellulose microfibrils resulting from beet and modified according to the same procedure as the sample MCBM1 are manufactured using different levels of BNA as compound B1.

TABLE 5

| | Name of the product | | | |
|---|---|---|---|---|
| | | | | Without |
| | MCBM1 | MCBM3 | MCBM4 | additive |
| Compound | 4/1 | 3/1 | 2/1 | 0 |
| B1/microfibrils ratio | | | | |
| Sag resistance of the | >1075 μm | >1075 μm | 675-700 μm | 350 μm |
| paint | | | | |

The modified cellulose microfibrils are subsequently added to the preceding epoxy/polyamine paint formulation. The level of modified microfibrils B is 0.4% by weight.

The results of the test of sag resistance to appear in Table 5 above.

Influence of the Nature of the Compound B1:

The cellulose microfibrils resulting from pine (coniferous) and modified according to the same procedure as the sample MCBM1 are manufactured using different compounds B1. The compound B1/cellulose microfibrils ratio is 4/1 by weight.

The modified cellulose microfibrils are subsequently added to the preceding epoxy/polyamine paint formulation. For MCBM 10 and 11, gels at 13% of B in xylene are used, as described above, while for MCBM12 to 21, gels at 6.5% in xylene were used. The level of additive B in the final paint is 0.4% by weight.

The results of the test of sag resistance appear in Table 6 below. Two measurements of the sag resistance were done on each paint: if only one value is present, it means that the result was the same for both trials, otherwise the 2 values are mentioned.

TABLE 6

| | Nature of the B1 | | |
|---|---|---|---|
| Additive | compound | Sag resistance | |
| None | — | 325-350 | μm |
| MCBM10 | BNA (lyophilized) | 625-650 | μm |
| MCBM11 | Lutrol ® F127 | 525-550 | μm |
| | (lyophilized) | | |
| MCBM12 | BNA (oven dried 60° C.) | 700-725 | μm |
| MCBM13 | Rhodafac RS 610 (50%)/ | 650-675 | μm |
| | Tergitol 15S20 (50%) | | |
| MCBM14 | Rhodafac RS610 | 550 | μm |
| MCBM15 | Disponil FES 993 | 550 | μm |
| MCBM16 | Servoxyl VPDZ 100 | 525 | μm |
| MCBM17 | Tween 85 | 500 | μm |
| MCBM18 | Servoxyl VPNZ 20/30 | 475 | μm |
| MCBM19 | Tergitol 15S20 | 450 | μm |
| MCBM20 | Servamine KW100 | 425 | μm |
| MCBM21 | Dowfax D2A1 | 400 | μm |

### EXAMPLE 2 (INVENTION)

### Application in a Bicomponent (2K) Acrylic Paint

The procedure described in Example 1 is followed, except that component 1 comprises an acrylic resin with the reference Cray Valley Synocure 878N60 and that component 2 is an isocyanate.

The formula of the paint appears in the following Table 7:

TABLE 7

| | | | |
|---|---|---|---|
| | Commercial | | Percentage by |
| Raw materials used | references | Suppliers | mass (%) |

COMPONENT 1

| | | | |
|---|---|---|---|
| Acrylic resin | Synocure 878N60 | Cray Valley | 46.10 |
| Pigment, TiO₂ | RCL 535 | Millenium | 27.07 |
| | | Chemical | |
| Dispersant | Disperbyk 161 | Byk Chemie | 0.50 |
| Butyl acetate | | Prolabo | 10.48 |
| 1-Methoxy-2- | Dowanol PMA | Aldrich | 3.49 |
| propyl acetate | | | |
| Ethyl acetate | | Prolabo | 1.16 |
| Thixotropic | Modified | | x |
| additive | cellulose | | |
| | microfibrils | | |

COMPONENT 2

| | | | |
|---|---|---|---|
| Isocyanate | Tolonate | Rhodia | 11.19 |
| | HDB75MX | | |
| Total | | | 99.99 + x |

The paints are treated, with as additives, beet cellulose microfibrils MCBM1 introduced at different levels into component 1.

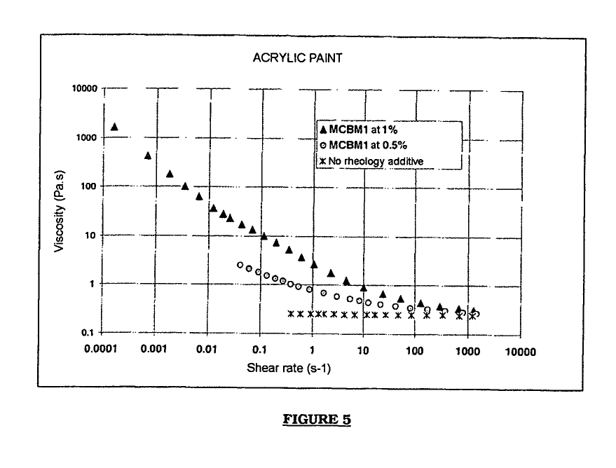

The flow curves of the acrylic paints are represented in FIG. 5.

A significant increase in shear thinning of the acrylic paints is observed when the level of beet cellulose microfibrils MCBM1 increases.

### EXAMPLE 3 (INVENTION)

### Application in a Polyester Resin

The cellulose microfibrils are evaluated in a commercial orthophthalic unsaturated polyester resin with the reference Cray Valley S21120A. The microfibrils are added either in the form of a premilled powder or in the form of a pregel obtained by mixing 13% of dry cellulose microfibrils and 87% of styrene. The gels in styrene are obtained in the same way as the gels in xylene of example 1.

The resins treated, with as additives, cellulose microfibrils are compared with the reference resin Cray Valley S21120A alone and with the reference resin Cray Valley S21120A treated, with as additive, 1% by weight of silica as thixotropic agent. The addition of the gel of microfibrils in the resin is obtained by hand assisted dispersion with the help of a spatula.

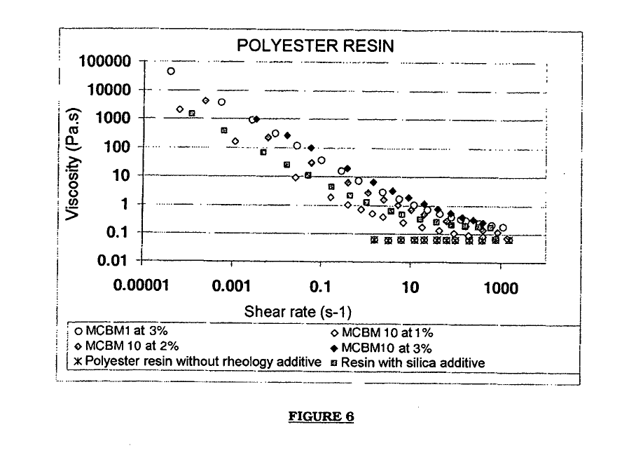

FIG. 6 shows the evolution of viscosity with the shear rate: the shear thinning effect by 1% of modified cellulosic microfibrils is comparable to the effect observed with 1% of silica without any thickening of the resin at higher shear rates.

### EXAMPLE 4 (INVENTION)

### Application in a Mastic

The procedure described in Example 1 is followed, except that the curing agent is replaced by a silanized polyether resin with the reference MS Polymer.

The formula of the mastic appears in the following Table 8:

TABLE 8

| | Commercial | | Percentage |
|---|---|---|---|
| Raw materials used | references | Suppliers | by mass (%) |
| Silylated | MS Polymer - S203H | Kaneka | 15.08 |
| polyether resin | | | |
| Silylated | MS Polymer - S203H | Kaneka | 10.05 |
| polyether resin | | | |
| Plasticizer, | Jayflex DIUP | ExxonMobil | 17.59 |
| diisoundecyl | | Chemical | |
| phthalate | | | |
| Pigment, TiO₂ | RL 90 | Tiona | 2.51 |
| Calcium carbonate | Carbital C110S | Imerys | 50.26 |
| Thixotropic | Modified cellulose | | x |
| additive | microfibrils | | |
| Water scavenger | Dynasylan VTMO | Degussa | 0.75 |
| | (vinyltrimethoxy- | | |
| | silane) | | |
| Total | | | 96.24 + x |

The cellulose microfibrils MCBM7 are dispersed in the plasticizer under cold conditions by firstly hand blending and then by Ultraturrax dispersions at 24000 rpm for 5 min. The polymers are subsequently mixed with the cellulose microfibrils prepared in the plasticizer until the mixture is homogeneous. Then, a part of the dehydrating agent, the fillers and the pigment are added. The mixture is stirred at 4000 rpm and held 2 hours to rise at 85° C. and then the rest of the dehydrating agent are subsequently added thereto at the end.

The viscosity recovery is measured using an SR5000 controlled-stress rheometer. The geometry used is plate-plate with a diameter of 25 mm and with regulation of the temperature by a Peltier plate at +23° C.

A shear stress of 1500 Pa is applied to the coating formulation for 15 seconds.

The viscosity of the formulation is subsequently measured under a constant stress of 100 Pa for 60 seconds at 23° C. (the stress simulates the sagging of the mastic joint).

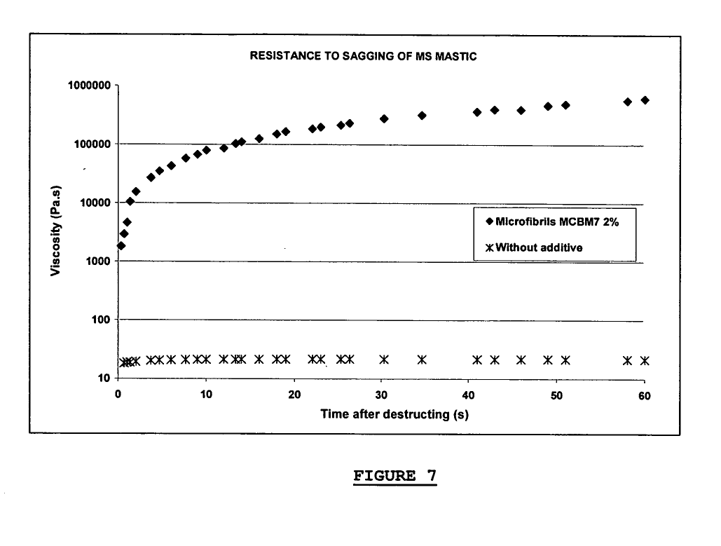

The recovery of viscosity of the various mastics is represented in FIG. 7, as a function of time.

From FIG. 7, the preparation of mastics having an acceptable slump resistance is therefore possible using cellulose microfibrils as thixotropic agent. The preparation of the mastic is then greatly simplified as the use of cellulose microfibrils does not require thermal activation.

### COUNTER-EXAMPLE 1 (COMPARATIVE)

A microcrystalline cellulose having an aspect ratio l/d<20 is prepared, the cellulose microfibrils resulting from wood being treated at a pH=2 obtained by adjustment with 1M sulphuric acid, and the mixture is left to react with stirring at 80° C. for 1 hour. The dispersion is subsequently rinsed until the pH is neutral and then the microcrystalline cellulose is treated with the compound B1 as already described. The thus obtained additive is tested in a paint based on epoxy-amine, as disclosed in Example 1 and then compared to the microfibrils according to the invention.

The results appear in Table 9 below:

TABLE 9

| | Source of | Nature of | Compound |
|---|---|---|---|
| Name of the | the | the compound | B1/microfibrils |
| product | cellulose | B1 | ratio |
| Microcrystalline | Pine | BNA | 4/1 |
| cellulose | (coniferous) | | |
| MCBM10 | Pine | BNA | 4/1 |
| | (coniferous) | | |

| Name of the | Mean cross- | | | Sag |
|---|---|---|---|---|
| product | section d | Length l | l/d ratio | Resistance |
| Microcrystalline | 10 nm | 100-200 nm | <20 | 300 μm |
| cellulose | | | | |
| MCBM10 | 8-12 nm | >1 μm | >100 | >1075 μm |

It is found that a minimum l/d ratio is necessary in order to obtain a significant thixotropic effect.

### FIGURES

The comparative effectiveness of the beet cellulose microfibrils MCBM1 and of the fatty acid diamide Crayvallac Ultra® in a two-component epoxy/polyamine paint, as described in Example 1, is presented in FIG. 1. The graph represents the recovery of viscosity after a stress of 700 Pa, read under a stress of 1 Pa, over 120 seconds.

The viscosity of two-component epoxy/polyamine paints as described in Example 1, as a function of the concentration of beet cellulose microfibrils MCBM1, after applying a pre-shear under 700 Pa, read under a stress of 1 Pa, at t=120 seconds, is presented in FIG. 2.

The sag resistance of a two-component epoxy/polyamine paint, expressed in μm, as a function of the concentration of beet cellulose microfibrils MCBM1, as described in Example 1, is presented in FIG. 3.

The comparative effectiveness of the beet cellulose microfibrils MCBM1, eucalyptus cellulose microfibrils MCBM9 and pine (coniferous) cellulose microfibrils MCBM10 in an epoxy/polyamine paint, as described in Example 1, is presented in FIG. 4. The graph represents the viscosity as a function of the shear rate applied.

The effectiveness of the beet cellulose microfibrils MCBM1 in a two-component acrylic paint, as described in Example 2, is presented in FIG. 5. The graph represents the viscosity as a function of the shear rate applied for different concentrations of beet cellulose microfibrils MCBM1.

The comparative effectiveness of a polyester resin treated, with as additives, cellulose microfibrils and with silica, as described in Example 3, is presented in FIG. 6. The graph represents the viscosity as a function of the shear rate applied.

The effectiveness of the pine (coniferous) cellulose microfibrils MCBM7 in a mastic based on silanized polyether resin, as described in Example 4, is presented in FIG. 7. The graph represents the viscosity as a function of the time after destructuring.

1) A coating or composite moulding or mastic composition, wherein it comprises, by weight:
A) 100 parts of at least one reactive or non-reactive organic binder
B) 0.001 to 20 parts of at least one additive comprising cellulose microfibrils modified at the surface by at least one compound B1, the said cellulose microfibrils having an aspect ratio l/d of greater than 20 and a mean cross-section d ranging from 1 to 50 nm, the said compound B1 having at least one hydrophilic part and at least one hydrophobic part, the said microfibrils being modified at surface by physical route by the physical adsorption of said compound B1
C) optionally, at least one organic diluent
D) optionally, up to 300 parts of at least one component chosen from fillers, fibres, pigments, dyes and other conventional additives.

2) The composition according to claim 1, wherein the said compound B1 is relatively soluble in the organic binder A and/or the organic diluent C.

3) The composition according to claim 1, wherein the cellulose microfibrils of the additive B are selected from those of wood, cotton, flax, ramie, certain algae, jute, sugarbeet pulp, citrus fruits, waste from the food processing industry or of bacterial origin or from animal origin.

4) The composition according to claim 1, wherein the said compound B1 as defined in claim 1 has a predominant hydrophobic nature.

5) The composition according to claim 1, wherein the said compound B1 comprises at least one surfactant.

6) The composition according to claim 5, wherein the said surfactant comprises at least one anionic surfactant or at least one cationic surfactant or at least one amphoteric surfactant or at least one nonionic surfactant, it being possible for the latter to be present in binary combination with each of the other three surfactants.

7) The composition according to claim 6, wherein the said surfactant comprises at least one nonionic surfactant and at least one anionic surfactant.

8) The composition according to claim 1, wherein the level by weight of the compound B1 is such that the ratio of the compound B1 to cellulose microfibrils is from 0.5/1 to 10/1.

9) The composition according to claim 5, characterized in that the said surfactant comprises at least one nonionic surfactant selected from: castor oil derivatives ethoxylated with 30 to 40 EO, hydrogenated castor oil derivatives ethoxylated with 7 to 60 EO, ethoxylated derivatives of coconut oil, soybean lecithin, C₆ to C₂₂ fatty alcohols polyethoxylated with 8 to 30 EO, polyethoxylated alkylphenols, ethoxylated arylphenols, polyglycol tridecyl alcohol ethers, block polyethers of di- and triblock type, sorbitol derivatives comprising 1 to 3 polyoxyethylene chains and 1 to 3 C₁₂ to C₃₀ fatty chains, C₈ to C₃₆ fatty acid esters ethoxylated with 8 to 30 EO, mono- and diglyceride esters of C₈ to C₃₆ fatty acids, C₈ to C₂₂ fatty amines, or mixtures thereof.

10) The composition according to claim 5, wherein the said surfactant comprises at least one anionic surfactant selected from: sulphate or phosphate esters of C₆ to C₂₂ fatty alcohols with 2 to 30 oxyalkylene units, polyalkoxylated alkylphenol phosphate esters, the alkyl substituent of which is a C₁ to C₁₂ alkyl substituent, with 5 to 25 oxyalkylene units, the said oxyalkylene unit being a C₂ to C₄ oxyalkylene unit, arylphenol phosphate esters with 5 to 25 EO, simple or mixed organic phosphate acid esters, or partially neutralized polycarboxylic acid salts.

11) The composition according to claim 10, wherein the said anionic surfactant is:
i) a polyalkoxylated alkylphenol phosphate ester, the alkyl substituent of which is a C₂ to C₈ alkyl substituent and the oxyalkylene of which is a C₂ oxyalkylene, or
ii) a specific simple or mixed organic phosphate acid ester: Beycostat® A B09.
iii) Rhodafac® RS610
iv) Disponil® FES 993

12) The composition according to claim 1, wherein the said organic binder A is reactive and is selected from epoxy/amines starting from crosslinkable two-component systems, unsaturated polyesters, vinyl esters, modified or unmodified alkyds, polyurethanes starting from crosslinkable two-component systems, and more particularly acrylic polyurethanes starting from crosslinkable two-component systems, acrylated acrylic oligomers, binders which can be crosslinked thermally or under UV and/or EB radiation, silanized polyethers or silanized polyurethanes.

13) The composition according to claim 1, wherein the said composition is a coating composition.

14) The coating composition according to claim 13, wherein it comprises at least one organic binder A selected from unsaturated polyesters or vinyl esters or acrylated acrylic oligomers and at least one organic diluent C selected from (meth)acrylic, allylic or vinylaromatic monomers.

15) The coating composition according to claim 13, wherein it comprises at least one organic binder A selected from the following crosslinkable two-component reactive systems: epoxy/amine or epoxy/polyamide systems comprising at least one epoxy resin, comprising at least 2 epoxy groups, and at least one amine or polyamide compound, comprising at least 2 amine groups, polyurethane systems comprising at least one polyisocyanate and at least one polyol, polyol/melamine systems, and polyester systems based on at least one epoxy or one polyol which reacts with at least one corresponding carboxylic acid or anhydride.

16) The coating composition according to claim 15, wherein the said organic binder A is a crosslinkable two-component polyurethane system or a polyester system based on epoxy/carboxylic acid or anhydride or polyol/carboxylic acid or anhydride or polyol/melamine, in which the polyol is a hydroxylated acrylic resin.

17) The coating composition according to claim 13, wherein the organic binder A is selected from modified or unmodified alkyds.

18) The coating composition according to claim 13, wherein it comprises at least one organic binder A which can be crosslinked thermally or under UV and/or EB radiation and which is selected from (meth)acrylic oligomers or acrylated acrylic oligomers or allylic oligomers which are multifunctional.

19) The composition according to claim 1, wherein the said composition is a mastic composition.

20) The mastic composition according to claim 19, wherein it comprises at least one organic binder A selected from unsaturated polyesters, vinyl esters, silanized polyethers or silanized polyurethanes.

21) The composition according to claim 1, wherein the said composition is a composite moulding composition.

22) The composite moulding composition according to claim 21, wherein it comprises at least one organic binder A selected from: unsaturated polyesters, vinyl esters, crosslinkable two-component epoxy/amine or epoxy/polyamide systems or crosslinkable two-component polyurethane systems.

23) A process for the preparation of a composition as defined according to claim 1, wherein it comprises at least one stage of mixing at least one additive, with at least one binder, and/or at least one organic diluent.

24) The preparation process according to claim 23, wherein the said mixing takes place with shearing and that the said additive B is introduced in the form of a powder or in the form of a preconcentrated intermediate composition comprising it.

25) A method of use of the composition as defined according to claim 1 comprising a step of preparing compositions for paints, varnishes, gel coats, inks, adhesives in a solvent medium, leaktightness agents, composite moulding or mastics.

26) An intermediate composition which can be used for the preparation of a composition as defined according to claim 1, wherein it comprises at least one additive B as described according to claim 1 at a concentration by weight ranging from 5 to 50% with respect to the total weight of the said composition, and at least one organic binder A as defined according to claim 1 and/or at least one organic diluent C as defined according to claim 1.

27) The intermediate composition according to claim 26, wherein it can be used for the preparation of a composition as defined according to claim 1 and in that it comprises at least one organic diluent C as defined according to claim 1, without any organic binder A.

28) The intermediate composition according to claim 27, wherein the said organic diluent C is selected from (meth)acrylic and/or allylic and/or vinylaromatic monomers, white spirit, alcohols, ketones, C₁ to C₄ alkyl esters, glycol ethers, plasticizers, aromatic, aliphatic or cycloaliphatic solvents, or their mixtures.

29) The intermediate composition according to claim 26, wherein, instead of the said organic diluent C, it comprises only at least one liquid organic binder A, in the absence of any organic diluent C.

30) The intermediate composition according to claim 26, wherein it is in the form of a powder or of an elastic pregel or of solid granules with a controlled particle size ranging from 0.5 to 20 mm.

31) A method of use of the composition obtained according to the process defined according to claim 23 comprising a step of preparing compositions for paints, varnishes, gel coats, inks, adhesives in a solvent medium, leaktightness agents, composite moulding or mastics.

32) An intermediate composition which can be used for the preparation of a composition obtained according to the process defined according to claim 23, wherein it comprises at least one additive B as described according to claim 1 at a concentration by weight ranging from 5 to 50% with respect to the total weight of the said composition, and at least one organic binder A as defined according to claim 1 and/or at least one organic diluent C as defined according to claim 1.
